(19) United States
(12) Patent Application Publication
(10) Pub. No.: US 2025/0059322 A1
(43) Pub. Date: Feb. 20, 2025

(54) METHOD FOR PRODUCING VARIOUS MOLECULAR WEIGHT POLYESTERS

(71) Applicant: SABIC GLOBAL TECHNOLOGIES B.V., Bergen op Zoom (NL)

(72) Inventors: Keshavaraja Alive, Evansville, IN (US); Robert Russell Gallucci, Mt. Vernon, IN (US)

(21) Appl. No.: 18/724,356

(22) PCT Filed: Dec. 19, 2022
(86) PCT No.: PCT/EP2022/086724

§ 371 Date: Jun. 26, 2024

(30) Foreign Application Priority Data
Dec. 27, 2021 (EP) 21217795.0

(51) Int. Cl. C08G 63/78; C08G 63/183; C08J 3/12; C08J 3/20; C08K 5/053

(52) U.S. Cl. CPC C08G 63/78; C08G 63/183; C08J 3/12; C08J 3/201; C08K 5/053; C08J 2367/06

(57) ABSTRACT

In an aspect, a method for reducing the molecular weight of a polyester comprises extruding a composition comprising a chain scission agent and a polyester in a molten state to form a modified polyester. The chain scission agent can comprise a C₂₋₁₂ diol and can be present in an amount of 0.1 to 5 weight percent based on the total weight of the composition. The polyester can comprise a C₂₋₁₂ alkyl phthalate polyester having a weight average molecular weight, Mwi, of 15,000 to 100,000 g/mol based on polystyrene standards. The modified polyester can have a weight average molecular weight, Mw_{f}, of at least 5% less than the weight average molecular weight of the polyester.

### TECHNICAL FIELD

This application relates to a system and method for making polyester and especially relates to a system and method for making a variety of molecular weights of C₂₋₁₂ alkyl phthalate polyesters.

### BACKGROUND

In the industry, when changing the molecular weight of a poly(butylene terephthalate), a continuous polymerization plant requires the adjustment of many polymerization parameters. For example, a high molecular weight poly(butylene terephthalate) is prepared under conditions of higher temperature and higher residence time as compared to a lower molecular weight poly(butylene terephthalate). Accordingly, when switching from one molecular weight poly(butylene terephthalate) to another molecular weight poly(butylene terephthalate), the following parameters are changed: the molar ratio of the monomers, the reaction temperatures in the oligomerization reactors, the reaction temperatures in the polymerization reactors, the amount of catalyst, and the overall throughput of the plant (residence time). This changeover can take several hours, where, during the several hour changeover from one molecular weight poly(butylene terephthalate) to another molecular weight poly(butylene terephthalate), a large amount of waste poly(butylene terephthalate) is produced. This problem is increasingly an issue as the size of poly(butylene terephthalate) plants increases. For example, in a large poly(butylene terephthalate) plant that produces more than 60,000 tons per year, a large amount of waste is undesirably produced during a changeover. As a result, the development of larger poly(butylene terephthalate) plants is hampered by inefficiencies of the changeover process.

Accordingly, improved methods for preparing poly(butylene terephthalate) are desired, where changeover between different molecular weight poly(butylene terephthalate) is simplified and/or the production of poly(butylene terephthalate) waste is reduced.

### BRIEF SUMMARY

Disclosed herein is a method for reducing the molecular weight of a polyester.

In an aspect, the method comprises adding a chain scission agent to the polyester in a molten state and having an initial melt viscosity to form a modified polyester having a reduced melt viscosity that is less than the initial melt viscosity.

In another aspect, the method for reducing the molecular weight of a polyester can comprise extruding a composition comprising a chain scission agent and a polyester in a molten state to form a modified polyester: the extruding can occur at a temperature of 230 to 330° C. the extruding can occur in an extruder comprising at least one screw rotating at a speed of 50 to 500 revolutions per minute: the chain scission agent can be present in an amount of 0.1 to 5 weight percent based on the total weight of the composition: the chain scission agent can comprise a C₂₋₁₂ diol: the polyester can comprise a C₂₋₁₂ alkyl phthalate polyester having a weight average molecular weight, Mwᵢ, of 15,000 to 100,000 g/mol based on polystyrene standards: the modified polyester can have a weight average molecular weight, Mw_{f}, of at least 5%, or 10 to 25% less than the weight average molecular weight of the polyester.

In another aspect, the method for reducing the molecular weight of a polyester can comprise adding a chain scission agent to a polyester in a molten state in an in-line mixer to form a polyester composition; wherein the polyester comprises a C₂₋₁₂ alkyl phthalate polyester having a weight average molecular weight, Mwᵢ, of 15,000 to 100,000 g/mol determined using gel permeation chromatography based on polystyrene standards; wherein the adding occurs at a temperature of 230 to 330° C.; wherein the in-line mixer can be at least one static mixer having a length of at least 50 cm: the chain scission agent can be present in an amount of 0.1 to 5 weight percent based on the total weight of the composition: the chain scission agent can comprise a C₂₋₁₂ diol: the modified polyester can have a weight average molecular weight, Mw_{f}, of at least 5%, or 10 to 25% less than the weight average molecular weight of the polyester.

The above described and other features are exemplified by the following figures, detailed description, and claims.

### BRIEF DESCRIPTION OF THE DRAWINGS

The following Figures are exemplary embodiments, which are provided to illustrate the present disclosure. The figures are illustrative of the examples, which are not intended to limit devices made in accordance with the disclosure to the materials, conditions, or method parameters set forth herein.

FIG. 1 is an exemplary illustration of a method of adding a chain scission agent to a polyester;

FIG. 2 is an exemplary illustration of a method of adding a chain scission agent to a polyester during polymerization:

FIG. 3 is a graphical illustration of the melt volume flow rate of Examples 4-8:

FIG. 4 is a graphical illustration of the viscosity with time of Examples 4-8:

FIG. 5 is a graphical illustration of the viscosity versus the shear rate data of Examples 4-8

FIG. 6 is a graphical illustration of the melt volume flow rate of Examples 9-13; and

FIG. 7 of the viscosity with time of Examples 9-13.

### DETAILED DESCRIPTION

When adjusting the molecular weight of a polyester in a continuous polymerization, the method conditions such as one or more of a monomer flow rate, a catalyst flow rate, a polymerization temperature, a polymerization pressure, and plant throughput are adjusted. The transition time in changing over production to the desired molecular weight polyester can take as many as several hours, resulting in the production of a large amount of waste polyester and/or polyester that does not meet the desired specifications, also referred to as off-spec polyester.

A method of reducing the molecular weight of a polyester was developed that can comprise adding a chain scission agent to the polyester in a molten state and having an initial melt viscosity to form a modified polyester having a reduced melt viscosity that is less than the initial melt viscosity. The method can comprise melting a plurality of polyester pellets to form the polyester in the molten state and then adding the chain scission agent. The method can comprise reacting an alkane diol and dicarboxylic acid in a continuous polymerization reaction to form the polyester; and extruding the chain scission agent and the polyester during the continuous polymerization reaction. The adding the chain scission agent can comprise transferring the chain scission agent through a melt line to the polyester and mixing the chain scission agent and the polyester in a mixer, for example, an in-line mixer, an extruder, or a continuously stirred tank. A weight ratio during the adding of the chain scission agent to the polyester can be 0.01:1 to 0.5:1.

The method for reducing the molecular weight of a polyester can comprise extruding a composition comprising a chain scission agent and a polyester in a molten state to form a modified polyester. The extruding can occur at a temperature of 230 to 330° C. The extruding can occur in an extruder comprising at least one screw rotating at a speed of 50 to 500 revolutions per minute. The method can comprise adding a chain scission agent to a polyester in a molten state in an in-line mixer to form a polyester composition. The adding can occur at a temperature of 230 to 330° C. The in-line mixer can be at least one static mixer having a length of at least 50 centimeters (cm). The composition can have a residence time in the extruder or in the in-line mixer of 0.5 to 5 minutes.

The chain scission agent can be present in an amount of 0.1 to 5 weight percent based on the total weight of the composition. The chain scission agent can comprise a C₂₋₁₂ diol. The polyester can comprise a C₂₋₁₂ alkyl phthalate polyester having a weight average molecular weight, Mwᵢ, of 15,000 to 100,000 g/mol, or 15,000 to 80,000 g/mol based on polystyrene standards. The modified polyester can have a weight average molecular weight, Mw_{f}, of at least 5% less, or 10 to 25% less than the weight average molecular weight of the polyester (for example, Mw_{f}≤Mwᵢ-5% Mwᵢ). An amount of the hydroxyl end groups of the modified polyester can be 50 to 250 milliequivalent of end group per kilogram of the modified polyester (meq/kg). An amount of the carboxyl end groups (CEG) of the modified polyester can be 20 to 100 meq/kg. A ratio of the hydroxyl end groups to the carboxylic end groups of the modified polyester can be 1.2 to 2.5.

The method according to the invention does not require a hydrolyzer. Without it, their no need to balance the extruder and hydrolyzer pressure, which is a standard practice in the prior at as explain in U.S. Pat. No. 4,620,032. Additionally the process according to the invention can be performed at a lower pressure, for example atmospheric pressure, which allows to have a safety improvement method with reduced cost and investment.

The method of adding a chain scission agent can be utilized in a polyester production line. Such a method for producing a different molecular weight polyester in a production line can occur without changing the processing conditions. In other words, the processing conditions (such as pressures, temperatures, monomer flow rates, and catalyst flow rate) can remain the same (i.e., they only fluctuate within normal operating parameters for making a single molecular weight polyester, for example, they can each independently vary within 5%, or, 1% of a specific value or of a set of values), yet various desired molecular weight polyester can be produced. Specifically, the method can involve polymerizing a polyester with an initial molecular weight in the polymerization system. In other words, the processing conditions are not adjusted to attain a different molecular weight polyester, but remain set to produce a high molecular weight polyester. After the final polymerization, if a different molecular weight polyester is desired, the molecular weight is reduced to the desired molecular weight (e.g., a final molecular weight) using a chain scission agent that acts to break the polymer chains and modify the molecular weight.

For example, a polymerization can operate at a set of conditions (for example, of temperature, pressure, residence time, catalyst concentration, monomer flow rate, or a combination comprising one or more of the foregoing, e.g., of temperature, pressure, residence time, and catalyst concentration) that remain within 5%, or within 1% of their set values prior to, during, and after the molecular weight adjustment. For example, the polymerization process can be operated at conditions such that the polymerized polyester has an initial melt viscosity prior to the addition of the chain scission agent, i.e., but for the addition of the chain scission agent. The chain scission agent can be added to the polyester to result in a modified polyester with a reduced melt viscosity. In this manner, the set of processing conditions does not change, but the molecular weight of the polyester can be easily adjusted merely by the introduction of a chain scission agent.

The present method can be especially beneficial in a large production facility with a production rate of greater than or equal to 65,000 tons per year (t/y), or greater than or equal to 100,000 t/y. For example, in a large production facility with a production rate of 65,000 t/y, a standard changeover time to change product could result in 4,000 tons of waste and/or off-spec polyester per transition. Reducing the changeover time to 0.5 hour can reduce the amount of waste and/or off-spec polyester generated by a factor of ten to only 5 tons of waste per transition and further reducing the changeover time to 0.2 hour can reduce the amount of waste generated to only 1.7 tons of waste polyester per transition. Hence, significant savings and improvements can be realized with the present method, which is especially evident in large scale polyester production plants, e.g., greater than 30,000 t/y, or greater than or equal to 40,000 t/y, or greater than or equal to 50,000 t/y, or greater than or equal to 60,000 t/y, or 30,000 to 80,000 t/y.

FIG. 1 is an illustration of an aspect of the present method. FIG. 1 illustrates that a polyester can be added to a mixer 2 via a supply line 6. The polyester can be added in a solid form or in a liquid (for example, molten) form. The chain scission agent can be added to the mixer 2 via melt line 4. A temperature of the melt line 4 and/or the mixer 2 can be 225 to 250 degrees Celsius (° C.), or 230 to 270° C., or 230 to 260° C. The modified polyester can exit the mixer 2 via product line 8. The mixer 2 can be an in-line mixer, for example, located upstream of an extruder. The mixer 2 can be an extruder. The mixer 2 can be a continuously stirred tank.

The method can comprise extruding the composition comprising a chain scission agent and a C₂₋₁₂ alkyl phthalate polyester having a weight average molecular weight, Mwᵢ, of 15,000 to 100,000 g/mol based on polystyrene standards and resulting in a modified polyester having a weight average molecular weight, Mw_{f}, of at least 5%, or at least 10%, or 10 to 25% less than the weight average molecular weight of the polyester. The extruding can be performed at atmospheric pressure.

Prior to the adding of the chain scission agent, the polyester can have an initial melt viscosity of 740 to 9,500 Poise. Melt Viscosity is determined by the standard procedure, ASTM 1238-20. After the adding of the chain scission agent, the polyester can have a reduced melt viscosity that less than that of the initial melt viscosity. A ratio of the initial melt viscosity to the reduced melt viscosity can be 1:0.9 to 1:0.1; or 1:0.8 to 1:0.5.

The method of adding the chain scission agent can be used to reduce the molecular weight of commercial grades of poly(butylene terephthalate) (PBT). Table 1 shows a list of 5 different grades of PBT and their respective melt viscosities and carboxylic acid end group (CEG) concentrations.

TABLE 1

| PBT Grade | Melt viscosity (Poise) | CEG (meq/kg) |
|---|---|---|
| 176 | 250 to 450 | 40 |
| 195 | 740 to 900 | 40 |
| 306 | 1,450 to 1,850 | 55 |
| 309 | 3,500 to 4,500 | 55 |
| 315 | 7,500 to 9,500 | 55 |

Considering the present method, an amount of a higher grade PBT, for example, of the 315 grade can be mixed with the chain scission agent to form any one or more of the lower grades, for example, any of the 309 grade, the 306 grade, the 195 grade, or the 176 grade. In another example, the initial PBT could be the 195 grade PBT that is mixed with the chain scission agent to form the 176 grade PBT. In the context of a continuous polymerization, the polymerization plant can be configured to polymerize one of the higher melt viscosity PBT grades and an amount of the chain scission agent can be added after the higher grade is formed. For example, the polymerization plant can be configured to produce the 315 grade and a chain scission agent can be added to the 315 grade PBT to form any of the 309 grade, the 306 grade, the 195 grade, or the 176 grade without changing the polymerization conditions.

The reduction in the melt viscosity after adding the chain scission agent can be dependent on the relative amount of the chain scission agent, the type of the chain scission agent, the temperature, and the residence time. The composition can comprise 0.1 to 5 weight percent, or 1 to 3 weight percent of the chain scission agent based on the total weight of the composition. The residence time after adding the chain scission agent can be 0.5 to 5 minutes.

An amount of the hydroxyl end groups of the modified polyester can be 50 to 250) meq/kg. The modified polyester can have a carboxylic acid end group concentration of 20 to 100 meq/kg, or 20 to 80 meq/kg, or 40 to 60 meq/kg. The modified polyester can have a carboxylic acid end group reduced by 5 to 10 meq/kg relative to the polyester. A ratio of the hydroxyl end groups to the carboxylic end groups of the modified polyester can be 1.2 to 2.5.

After adding the chain scission agent, the modified polyester can be pelletized. Examples of pelletizers include water slide pelletizers, strand pelletizers, or underwater pelletizers. The pellets comprise cylinders with an average length of 2.0 to 6.0 mm and an average diameter of 0.5 to 4.0 mm. The pellets can have at least one angular face and wherein the surfaces defining the angular face meet at an angle of 60 to 120 degrees.

The polyester can comprise at least one C₂₋₁₂ alkyl phthalate polyester. The polyester can comprise at least one of poly(ethylene terephthalate), poly(butylene terephthalate), or a copolymer comprising at least one of the foregoing. The polyester can comprise, can consist essentially of, or can consist of poly(butylene terephthalate). The polyester can comprise a copolymer of the polyester and another polymer, for example, a polycarbonate.

The composition can comprise at least 10 ppm by weight, or at least 50 ppm by weight, or 10 to 200 ppm by weight of at least one of titanium, tin, antinomy, or a combination comprising at least two of the foregoing based on the total weight of the composition. The composition can comprise less than or equal to 1,000 ppm by weight of a phosphorous containing compound based on the total weight of the polyester composition. The composition can comprise less than or equal to 1 ppm by weight of lead, mercury, cadmium, thallium, chromium, arsenic, or a combination comprising at least two of the foregoing based on the total weight of the polyester composition.

The method can further comprise preparing the polyester. The method of preparing the polyester is not limited. For example, the polyester can be prepared in a two-stage process including an oligomerization stage and a polymerization stage. The oligomerization stage can comprise transesterifying a dicarboxylic acid with an alkane diol in the presence of a catalyst to form an intermediate weight oligomer. The polymerization stage can produce a higher molecular weight polyester by polycondensation of the intermediate weight oligomer under reduced pressures and increased temperatures. The chain scission agent can be added to the polyester after the polymerization is completed. For example, the chain scission agent can be added after a final polymerization (e.g., after a final polymerization unit). As used herein, “after final polymerization” refers to a time after which the Mw does not increase by greater than 10 wt %, or by greater than or equal to 5 wt % after final polymerization.

In general, the first stage of preparing a polyester oligomer comprises reacting an alkane diol and a dicarboxylic acid in excess of the alkane diol and in the presence of a catalyst. The monomer mixer can be heated to a temperature of 160 to 180° C. When the temperature of the reaction mixture is in the range of approximately 160 to 180° C., the temperature can be raised to 220 to 265° C. to initiate the ester interchange. Depending on the starting monomers, the overheads can include methanol, tetrahydrofuran (THF), water (H₂O), or unreacted alkane diol, which can be sent to a distillation column for recovery of water and tetrahydrofuran. Excess alkane diol can be recovered as column bottom and recycled back to the process.

The ester interchange can be complete when the clearing point is reached based on visual inspection. As used herein the “clearing point” occurs when the reaction medium becomes homogeneous melt. The clearing point can vary depending on the reaction conditions such as the dicarboxylic acid to alkane diol ratio, reaction temperature, operating pressure, residence time, and reflux ratio. After the clearing point is reached, the pressure can be reduced to about 50 to 760 millimeters of mercury (mm Hg) and the temperature can be maintained at 230 to 260° C. for sufficient time to achieve desired melt viscosity and CEG values in the resulting PBT oligomer. At the completion of the reaction, the pressure can be returned to atmospheric pressure and the oligomer can be analyzed. The resulting oligomer can be cooled to a solid, then flaked, powdered, or pelletized, and used to make resin.

In the oligomerization stage, the alkane diol can be present in excess. A molar ratio of the alkane diol to the dicarboxylic acid can be 6:1 to 2:1, or 4.25:1 to 2.95:1. The molar ratio of alkane diol to dicarboxylic acid can vary depending on the desired melt viscosity and CEG of the resulting polyester oligomer. For example, to achieve an intrinsic viscosity (IV) of approximately 0.13 to 0.17 deciliters per gram (dl/g) and a CEG of 90 to 180 meq/kg, a molar ratio of the alkane diol to the dicarboxylic acid of 3:1 can be used. Alternatively, to achieve an IV of 0.25 to 0.43 dl/g and a CEG of lower than 20 meq/kg, the alkane diol to the dicarboxylic acid molar ratio of 4:1 can be used.

It is noted that variation in CEG concentration after the first stage of the process can have downstream consequences for the rest of the process, particularly at the polycondensation stage. This variation can translate into variations in CEG concentration in the resulting polyester. Typically. IV increases during the polycondensation step with a simultaneous decrease in CEG concentration. However, depending on the residence time of the polycondensation step, the CEG concentration can potentially increase due to side reactions such as through a back-biting reaction of the alkane diol end groups. The uncertainty associated with variability in the reaction conditions and times for the polymerization (particularly when the process is continuous) makes controlling CEG concentration in the polyester a challenge.

The oligomers can then be reacted in a pre-polycondensation reaction where a low molecular weight polyester is formed. The low molecular weight polyester can be further reacted in a polycondensation reaction (polymerization reaction) to produce the polyester having the initial melt viscosity. The polycondensation reaction can occur in a finishing reactor. The polymerization can occur at a temperature of 230 to 260° C. One or both of an additional alkane diol or an additional catalyst can be added to the polymerization. The polymerization can occur under mixing and/or at a vacuum pressure of less than or equal to 1 millimeter of mercury. The polymerization can occur for 15 to 120 minutes. Excess alkane diol can be recovered as column bottom and recycled back to the process. After the polymerization, the pressure can be changed to atmospheric, for example, 1 bar.

After the polymerization, the chain scission agent can be added to the polyester to form the modified polyester having a reduced melt viscosity. The chain scission agent can be premixed with the polyester prior to the extruder or the chain scission agent can be added directly to the extruder, for example, in a downstream inlet from where the polyester is added.

The polycondensation of the oligomer to make the polyester with a specified melt viscosity and CEG can be carried out continuously using industrial-scale equipment comprising a melt tank for melting oligomers, one or more reactors for post-condensation processing, and one or more finishing reactors to increase molecular weight. The reactor can further comprise a slurry paste vessel and reactor units to form the oligomer. In an example, the polymerization of polyester can employ 1 to 6, or 4 to 6 continuous reactors followed by 1 to 2 finishers. Examples of finishers include disc cage reactors or disc ring reactors (DRR). The finisher can include an inline viscometer that can be coupled to a feed-back loop that can control at least one of the temperature, absolute pressure, and the level of the components in the finisher.

The finisher can include a disc ring reactor. The disc ring reactor can have a two shaft reactor with the first shaft having more disc rings than the second shaft, where each of the shafts operate at two different rotation speeds. For example, the first shaft can have 5 or 6 disc rings and can rotate at a rotation speed of 4 to 10 revolutions per minute (rpm) and the second shaft can have 3 or 4 disc rings and can rotate at a rotation speed of 2.2 to 5 rpm. A distance between the rings of the first shaft can be 60 and 90 millimeters (mm). A distance between the rings of the second shaft can be 100 to 130 mm.

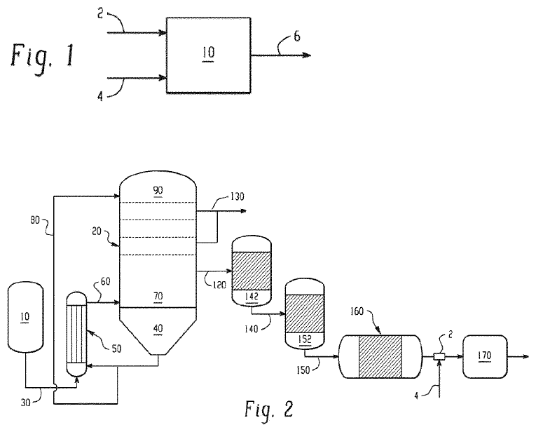

An example of a polyester polymerization is illustrated in FIG. 2. FIG. 2 illustrates that the dicarboxylic acid and the alkane diol can be mixed in a slurry paste vessel to form a monomer mixture. The monomer mixture can be transferred via supply line 30 to tower reactor 20. Tower reactor 20 can include hydrocyclone 40, heat exchanger 50, pressure pipe 60 connecting the upper portion of the heat exchanger 50 to the esterification section 70, and pipe stretch 80 connecting the esterification section 70 to the cascade post-esterification section 90 of the tower reactor 20. Pipe 120 can connect the lower end of the cascade post-esterification section 90 to first continuously stirred tank reactor 142. Byproducts and excess alkane diol can be vented from the tower reactor 20 via vent 130. The first continuously stirred tank reactor 142 can be connected to a second continuously stirred tank reactor 152. The second continuously stirred tank reactor 152 can be connected to a finishing reactor 160. A chain scission agent can be added to the polyester via melt line 4. The melt line 4 can be directed to a mixer 2. Mixer 2 can be, for example, an inline mixer or a continuously stirred tank. The mixer 2 can be connected to a pelletizer 170. If the mixer 2 is an extruder, then the pelletizer 170 can be a single unit with the extruder.

The polymerization process can comprise combining a dicarboxylic acid and an alkane diol in a slurry paste vessel 10 to form a monomer mixture. The temperature, pressure, and a residence time in the slurry paste vessel 10 can be sufficient to allow the slurry/paste to form. The temperature in the slurry paste vessel 10 can be 20 to 110° C., or 50 to 100° C., or 70 to 90° C. The pressure in the slurry paste vessel 10 can be 0.1 to 1.1 bar, or 0.8 to 1.05 bar, or 0.9 to 1.02 bar. The residence time in the slurry paste vessel 10 can be 1 to 4 hours, or 2.5 to 3.5 hours.

A catalyst and the monomer mixture can be supplied from the slurry paste vessel 10 to the esterification section 70 of the tower reactor 20. Tower reactors are known in the art and can be configured such that the lower third of the tower reactor is in the form of a hydrocyclone 40 with attached heat exchanger 50, and the hydrocyclone 40 can have a supply line 30 from the slurry paste vessel 10 and that is connected via a pressure pipe 80 to the cascade post-esterification section 90 of the tower reactor 20. The cascade post-esterification section 90 of the tower reactor 20 can be configured in the form of a downflow cascade and the cascade is in communication via a pipe with the central part, esterification section 70, of the tower reactor 20.

A temperature in the esterification section 70 can be 160 to 270° C., or 160 to 180° C. A pressure in the esterification section 70 can be 0.5 to 1 bar. The reaction product of the esterification section 70 can be transferred continuously to the cascade post-esterification section 90 of the tower reactor 20 via pipe stretch 80. An additional amount of the alkane diol can be added to the cascade post-esterification section 90. The cascade post-esterification section 90 can comprise 1 to 8, or 3 to 5 cascades in series. A pressure in each subsequent cascade can be reduced by an amount such that the pressure in the final cascade is less than or equal to 0.25 bars, or less than or equal to 0.2 bars. An additional amount of catalyst can be added to the final cascade.

The reaction product, comprising the oligomer, from the cascade post-esterification section 90 of the tower reactor 20 can be continuously supplied to the first continuously stirred tank reactor 142. It is noted that for the purposes of the present disclosure, the method can comprise obtaining an oligomer that was not obtained in the present method. For example, a pelletized oligomer can be melted in a melt tank and supplied to the first continuously stirred tank reactor 142 via pipe 120. Pipe 120 can be heated, for example, at a temperature of 230 to 270° C.

The first continuously stirred tank reactor 142 can be at a temperature of 220 to 270° C., or 225 to 250° C. The first continuously stirred tank reactor 142 can be at a pressure of 5 to 40 millibars. A residence time in the first continuously stirred tank reactor 142 can be 10 minutes to 7 hours, or 3 to 6 hours, or 40 to 150 minutes, 10 to 60 minutes.

The reaction product, comprising a low molecular weight polyester from the first continuously stirred tank reactor 142 can be supplied to a second continuously stirred tank reactor 152 and then to a finishing reactor 160 or it can be supplied directly to the finishing reactor 160. The second continuously stirred tank reactor 152 can be at a temperature of 230 to 260° C. The second continuously stirred tank reactor 152 can be at a pressure of 0.1 to 35 millibars. A residence time in the second continuously stirred tank reactor 152 can be 10 to 60 minutes.

One or both of the continuously stirred tank reactors can include an inline viscometer coupled with a feedback loop that can control at least one of the temperature, the pressure, or the flow rates in and out of the reactor of the various streams and/or catalyst.

The finishing reactor 160 can be at a temperature of 230 to 270° C., or 230 to 255° C. The finishing reactor 160 can be at a pressure of 0.1 to 16 millibar, or 0.8 to 5 millibars. A residence time in the finishing reactor 160 can be 30 minutes to 10 hours, or 4 to 9 hours. The polyester in a molten state can be formed in the finishing reactor 160. The polyester can have the initial melt viscosity.

At least a portion of the polyester can be mixed with the chain scission agent. For example, 10 to 100 volume percent of the polyester based on the total volume of the polyester can be mixed with the chain scission agent and 0 to 90 volume percent of the polyester based on the total volume of the polyester can be directed to a pelletizer (not illustrated). The chain scission agent can be added to the polyester via melt line 4. A temperature of at least one of the melt line 4 or the mixer 2 can be 230 to 260° C. A pressure of the mixer 2 can be 1.01 to 1.1 bar. The melt line 4 can be directed to a mixer 2 to form the modified polyester. The modified polyester can be directed to a pelletizer 170.

A feedback loop can be employed to monitor the chain scission process, where, for example, the viscosity of the polyester and/or the modified polyester can be monitored and the flow rate of the chain scission agent can be adjusted based on the measured viscosity. The viscosity can be measured, for example, using an in-line viscometer or can be determined based on flow and pressure measurements.

The dicarboxylic acid can comprise at least one of an aromatic dicarboxylic acids (for example, having 8 to 14 carbon atoms), an aliphatic dicarboxylic acid (for example, having 4 to 12 carbon atoms), or a cycloaliphatic dicarboxylic acid (for example, having 8 to 12 carbon atoms). The dicarboxylic acid can comprise at least one of terephthalic acid, isophthalic acid, naphthalene dicarboxylic acid, cyclohexane dicarboxylic acid, stilbene dicarboxylic acid, succinic acid, glutaric acid, adipic acid, or azelacic acid. The dicarboxylic acid can comprise a purified dicarboxylic acid, for example, a purified terephthalic acid. The purified dicarboxylic acid typically comprises less than or equal to 10 weight percent of impurities as measured using conventional techniques based on the total weight of the purified dicarboxylic acid.

The alkane diol can comprise at least one of a C₂₋₁₂ alkane diol or a C₂₋₄ alkane diol. The alkane diol can comprise at least one of diethylene glycol, 1,2-propanediol, neopentyl glycol, 1,4-butanediol, 1,5-pentanediol, and 1,6-hexanediol. The alkane diol can comprise 1,4-butanediol. A mole ratio of the alkane diol to the dicarboxylic acid can be 1.2:1 to 3.5:1, or 1.3:1 to 2.0:1, or 1.35:1 to 1.75:1.

The chain scission agent can comprise at least one of a C₂₋₁₂ alkane diol or a C₂₋₄ alkane diol. The alkane diol can comprise at least one of diethylene glycol, 1,2-propanediol, neopentyl glycol, 1,4-butanediol, 1,5-pentanediol, and 1,6-hexanediol. The alkane diol can comprise 1,4-butane diol.

At least one of the alkane diol and the chain scission agent can be purified. For example, at least one of the alkane diol and the chain scission agent can comprise less than or equal to 1 weight percent of the combined weight of each of the following hydroxy butyraldehyde, succinic aldehyde, succinic semialdehyde, succinic acid, hydroxy butyrate, butene diol, butylene diol, tetrahydrofuran, ethylene glycol, and propylene glycol, based on the total weight of the alkane diol or the chain scission agent.

The alkane diol and the chain scission agent can be the same.

The catalyst can comprise at least one of a titanium alkoxide, a tin-containing compound, or a zirconium-containing compound. The titanium alkoxide can comprise at least one of tetraisopropyl titanate, tetraisobutyl titanate, tetra tert-butyl titanate, tetraphenyl titanate, tetraethylhexyl titanate, a bis(alkanediolato) titanate, or a reaction product thereof with a phosphorous compound (such as phosphoric acid, monoalkyl phosphate or monoaryl phosphate). The tin-containing compound can comprise at least one of tin diacetate, tin dioctoate, tin dilaurate, dibutyl tin dilaurate, or dibutyl tin acetate. The zirconium-containing compound can comprise at least one of tetra-n-propyl zirconate or tetra-n-butyl zirconate. The catalyst can comprise a tin alkoxide, such as tetraisopropyl titanate, tetraisobutyl titanate or tetra tert-butyl titanate. The catalyst can comprise tetraisopropyl titanate. The catalyst can be present in an amount of 40 to 250 ppm, or 50 to 200 ppm, or 70 to 150 ppm by weight based on the total weight of the dicarboxylic acid and the alkane diol.

An additive can further be added to the polyester, either before and/or after addition of the chain scission agent. The additive can be added in a molten state or can be added after an extruded polyester is re-melted. The additive can be filtered prior to being added into the polymerization unit.

The additive can comprise at least one of an impact modifier, a flow modifier, a filler (e.g., a particulate polytetrafluoroethylene (PTFE), glass, carbon, a mineral, or metal), a reinforcing agent (e.g., glass fibers), an antioxidant, a heat stabilizer, a light stabilizer, an ultraviolet (UV) agent (such as a UV light stabilizer and a UV absorbing additive), a plasticizer, a lubricant, a release agent (such as a mold release agent (such as glycerol monostearate, pentaerythritol stearate, glycerol tristearate, stearyl stearate, and the like)), an antistatic agent, an antifog agent, an antimicrobial agent, a colorant (e.g., a dye or pigment), a surface effect additive, a radiation stabilizer, a flame retardant, or an anti-drip agent (e.g., a polytetrafluoroethylene-encapsulated styrene-acrylonitrile copolymer (TSAN)). For example, a combination of a heat stabilizer, mold release agent, and ultraviolet light stabilizer can be used. In general, the additives are used in the amounts generally known to be effective. For example, the total amount of the additive composition (other than any impact modifier, filler, or reinforcing agent) can be 0.001 to 10 weight percent (wt %), or 0.01 to 5 wt %, each based on the total weight of the polyester composition.

The method for reducing the molecular weight of a polyester can comprise extruding a composition comprising a chain scission agent and a polyester in a molten state to form a modified polyester. The extruding can occur at a temperature of 230 to 330° C. The extruding can occur in an extruder comprising at least one screw rotating at a speed of 50 to 500 revolutions per minute. The method can comprise adding a chain scission agent to a polyester in a molten state in an in-line mixer to form a polyester composition. The adding can occur at a temperature of 230 to 330° C. The in-line mixer can be at least one static mixer having a length of at least 50 cm. The composition can have a residence time in the extruder or in the in-line mixer of 0.5 to 5 minutes. The chain scission agent can be present in an amount of 0.1 to 5 weight percent based on the total weight of the composition. The chain scission agent can comprise a C₂₋₁₂ diol. The polyester can comprise a C₂₋₁₂ alkyl phthalate polyester having a weight average molecular weight, Mwᵢ, of 15,000 to 100,000 g/mol based on polystyrene standards. The modified polyester can have a weight average molecular weight, Mw_{f}, of at least 5% less, or 10 to 25% less than the weight average molecular weight of the polyester. The modified polyester can have a carboxylic acid end group concentration of 20 to 100 meq/kg. A ratio of the hydroxyl end groups to the carboxylic end groups of the modified polyester can be 1.2 to 2.5. The method can further comprise reacting an alkane diol and terephthalic acid in a continuous polymerization reaction to form the polyester; and extruding the composition during the continuous polymerization reaction, but after a final polymerization; and optionally pelletizing the modified polyester after the extruding. The method can further comprise melting a plurality of polyester pellets to form the polyester in the molten state and then extruding the composition. The extruding the chain scission agent can comprise transferring the chain scission agent through a melt line to the extruder; and mixing the chain scission agent and the polyester in an in-line mixer; wherein the temperature of the melt line can optionally be 230 to 260° C. The weight ratio of the chain scission agent to the polyester can be 0.01:1 to 0.5:1. A pressure during the extruding of the chain scission agent can be atmospheric, or 1.01 to 1.1 bar. The modified polyester can have an amount of hydroxyl end groups of 50 to 250 meq/kg. The modified polyester can have a carboxylic acid end group concentration of 20 to 100 meq/kg. The modified polyester can have a ratio of hydroxyl to carboxylic acid end groups of 1.2 to 2.5.

The chain scission agent can comprise less than or equal to 1 weight percent of the combined weight of each of the following hydroxy butyraldehyde, succinic aldehyde, succinic semialdehyde, succinic acid, hydroxy butyrate, butene diol, butylene diol, tetrahydrofuran, ethylene glycol, and propylene glycol, based on the total weight of the chain scission agent. The polyester can comprise at least 50 ppm by weight of at least one of titanium, tin, antinomy, or a combination comprising at least two of the foregoing based on the total weight of the polyester. The polyester can comprise less than or equal to 1,000 ppm by weight of a phosphorous containing compound based on the total weight of the polyester based on the total weight of the polyester. The polyester can comprise less than or equal to 1 ppm by weight of lead, mercury, cadmium, thallium, chromium, arsenic, or a combination comprising at least two of the foregoing based on the total weight of the polyester.

The following examples are provided to illustrate the present disclosure. The examples are merely illustrative and are not intended to limit devices made in accordance with the disclosure to the materials, conditions, or method parameters set forth therein.

### EXAMPLES

The carboxylic acid end group (CEG) concentration was determined in accordance with ASTM D7409-15 by potentiometric titration by dissolving 0.5 grams of the PBT sample in 30 milliliters of O-cresol in 150 milliliter glass beakers on a hot plate at 200° C. After dissolution and cooling of the solutions, the samples were diluted with 50 milliliters of 3:1 diluent (dichloromethane: O-cresol) solution. The resultant solution was titrated using 0.01 normal (N) alcoholic KOH solution. The end point was determined potentiometrically by using Metrohm autotitrator. The total acidity was calculated by using base strength & volume consumed and results were expressed in terms of milliequivalents of KOH consumed per kilogram (meq/kg) of sample.

The Intrinsic Viscosity (IV) of the oligomers was measured using an automatic VISCOTEK MICROLAB™ 500 series Relative Viscometer Y501. 0.5 grams of oligomer sample were fully dissolved in a 60 to 40 mixture (% volume) of phenol and 1,1,2,2-tetrachloroethane solution (Harrell Industries). Two measurements were taken for each sample, and the reported result was the average of the two measurements.

Differential scanning calorimetry was run with a 20 degrees Celsius per minute (° C./min) heating rate. Melt volume rate was determined at a temperature of 250° C. with 6 minute equilibration using a 2.16 or 1.16 kilogram weight and is reported as cubic centimeters per 10 minutes (cc/10 min) on 7 gram samples dried at 150° C. for 1 hour.

Viscosity vs. time (dwell) was measured at 250° C. or 240° C. as per Rheo-M01, samples were dried at 125° C. for 2 hours. Viscosity vs. shear rate (MVM) was determined on dried pellets at 250° C. Tₘₗ stands for the first pass melting temperature, dHₘₗ stands for the first pass change in enthalpy during melting, dH_{cl} stands for the first pass change in enthalpy of melting the crystal, T_{c} stands for the crystalline temperature, and J/g stands for Joules per gram.

Gel permeation chromatography (GPC) was determined based on polystyrene standards, where Mw is the weight average molecular weight and Mn is the number average molecular weight.

### Example 1

PBT 309, having a melt viscosity of 4,009 Poise and an end group acid concentration of 34 meq/kg, was fed into the OMEGA 30T twin screw devolatilization extruder at a rate of 2 kilograms per hour, in which the barrel temperature of 240° C. was maintained. 1,4 butane diol was added through a separate inlet port to the extruder at the rate of 24 grams per hour. The residence time was adjusted to 2 minutes. The melt viscosity of the polymer collected at the exit of the extruder was 1800 poise and thus transition to a lower molecular weight resin grade, PBT 306 was achieved. The end group acid concentration was 27 meq/kg.

### Example 2

Two kilograms of PBT 309, having a melt viscosity of 4,009 Poise, was pre-mixed with 24 grams of 1,4 butane diol. The premixed material was fed into the OMEGA 30T twin screw devolatilization extruder, in which the barrel temperature of 240° C. was maintained. The residence time was adjusted to 3 minutes. The melt viscosity of the polymer collected at the exit of the extruder was 1,760 poise and thus transition to a lower molecular weight resin grade, PBT 306 was achieved. The end group acid concentration was 29 meq/kg.

### Example 3

Two kilograms of PBT 309 was fed into the OMEGA 30T twin screw devolatilization extruder, in which the barrel temperature of 240° C. was maintained. 1,4-butane diol was added through a separate inlet port to the extruder at the rate of 24 grams per hour. The residence time was adjusted to 3 minutes. The melt viscosity of the polymer resin collected at the exit of the extruder was 890 poise and thus transition to a lower molecular weight resin grade, PBT 195 was achieved. The end group acid concentration was 30 meq/kg.

### Examples 4-8

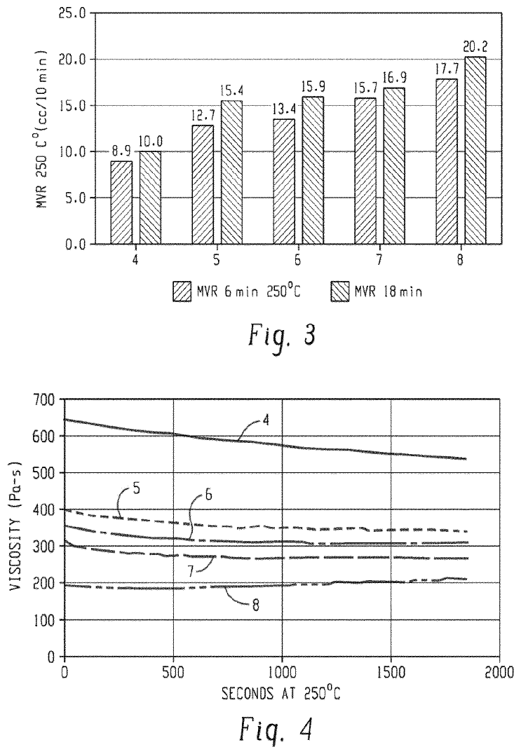

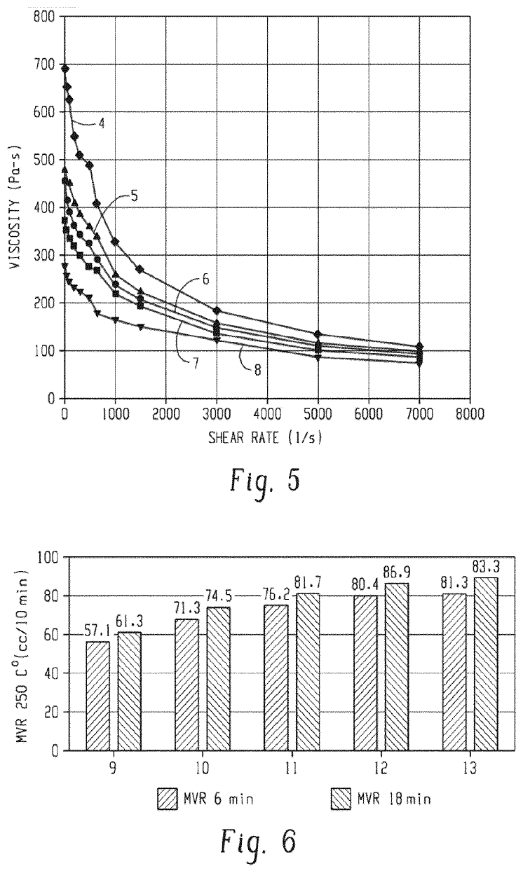

In Examples 4-8, extrusion compositions were prepared by extruding the compositions as shown in Table 2. The compositions were extruded in a COPERION T9 a 10 barrel, 26 mm co-rotating twin screw extruder. The conditions of the extruder were set as follows: the barrel temperatures from feed throat to die were 177° C., 232° C., 260° C., 260° C., 260° C., 252° C., 252° C., 254° C., 249° C., and 252° C., vacuum was not applied, the downstream vent was open to the atmosphere, the screw speed was 425 rpm, and the feed rate 29.5 kilograms per hour. the melt temperature of the poly(butylene terephthalate was 252° C. Formulations are shown in the tables below. Four kilogram batches were run through the extruder by feeding all ingredients through a throat by a single loss in weight feeder. Strands were well controlled and had sufficient melt strength to support themselves before contact with the water bath. Pellet cut was acceptable with no strand breakage at the chopper even for the lowest Mw samples. A four hole die was used. Blends were not dried prior to extrusion. No melt filtration or screen pack was used. The resulting compositions were analyzed and the results for Examples 4-8 are shown in Table 2 and in FIG. 3, FIG. 4, and FIG. 5.

The molecular weight data, comparing Example 4 to Examples 5-8, shows that the molecular weight did in fact decrease with addition of the butanediol. The CEG data shows that there is a slight drop in the CEG with addition of the butane diol.

TABLE 2

| Example | 4 | 5 | 6 | 7 | 8 |
|---|---|---|---|---|---|
| PBT 315 Pellets (wt %) | 50 | 50 | 50 | 50 | 50 |
| PBT 315 Fines (wt %) | 50 | 49.84 | 49.74 | 49.65 | 49.5 |
| Butanediol (wt %) | — | 0.16 | 0.25 | 0.35 | 0.5 |

Properties

| | | | | | |
|---|---|---|---|---|---|
| Mw (g/mol) | 96,944 | 93,724 | 93,037 | 91,606 | 89,922 |
| Mn (g/mol) | 28,530 | 28,164 | 28,037 | 27,587 | 27,249 |
| MVR, 6 min, 2.16 kg/250° C. (cc/10 min) | 8.9 | 12.7 | 13.4 | 15.7 | 17.7 |
| MVR, 18 min, 2.16 kg/250° C. (cc/10 min) | 10 | 15.4 | 15.9 | 16.9 | 20.2 |
| % change MVR from 6 to 18 min (%) | 12.4 | 21.3 | 18.7 | 7.6 | 14.1 |
| Tₘ₁ (° C.) | 222.8 | 222.3 | 223.2 | 223 | 223.3 |
| dHₘ₁ (J/g) | 46.4 | 47.1 | 44.1 | 47.3 | 45.9 |
| T_{c} (° C.) | 188.2 | 188.9 | 189.1 | 189.6 | 190.2 |
| dH_{c1} (J/g) | −49.3 | −50.7 | −50.4 | −51.4 | −50.3 |
| CEG (meq/kg) | 55.3 | 47.9 | 50.3 | 47.2 | 46.5 |
| MV Dwell 250° C. (Pa · s) | 642 | 396 | 356 | 309 | 193 |
| MV Dwell 30 minute (Pa · s) | 536 | 339 | 307 | 270 | 211 |
| % change in MV dwell (%) | 19.8 | 16.8 | 16 | 1.4 | −8.5 |

The MVR values of the extruded PBT and are shown in FIG. 3. The high processing temperature of PBT (250° C.) and the low boiling point of the BDO (230° C.) suggests that the BDO would be escaping from the blend and reacting at the same time. FIG. 3 surprisingly suggests that since the changes in Mw and viscosity were relatively well controlled, the BDO loss was minimal. The relatively small change between the 6 and 18 minute MVR dwell at 250° C. (FIG. 3), further indicates that the reaction is largely complete in the extruder with the percentage of any further MVR change in most instances below 20%.

RHEOM01 dwell tests were performed on Examples 4-8 and the results are shown in FIG. 4. In FIG. 4, the data shows that the examples that were mixed with the butane diol have good melt stability with less change in viscosity than that of Example 4. Without intending to be limited by theory, is believed that the change in viscosity is due the continued presence of the active catalyst and some ongoing reaction between the —COOH and —OH end groups.

The viscosity versus the shear rate data at 250° C. for Examples 4-8 is shown in FIG. 5. FIG. 5 shows that there is a drop in the melt viscosity with increased amounts of the butanediol.

### Examples 9-13

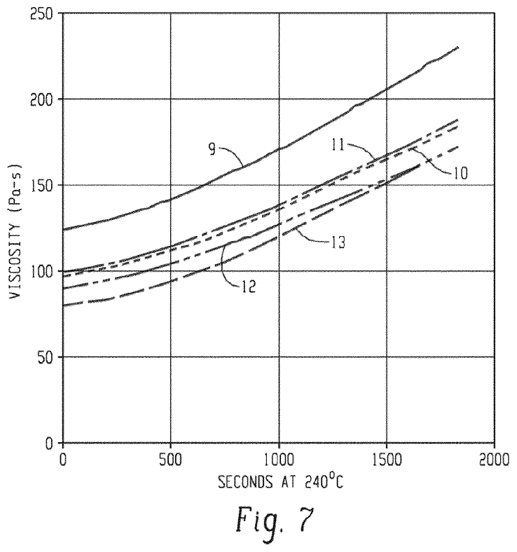

Examples 9-13 were prepared in accordance with Examples 4-8 except that PBT 195 pellets were used. The amounts of the respective composition are shown in Table 3. The resulting compositions were analyzed and the results are shown in Table 2 and in FIG. 6 and FIG. 7. It is noted that all of Examples 10-13 were able to be stranded and chopped with no strand breakage or excessive pellet fracture. Since the molecular weight of these samples was less than that of Example 4-8, the MVR data was obtained using a 1.16 kg weight.

TABLE 3

| Example | 9 | 10 | 11 | 12 | 13 |
|---|---|---|---|---|---|
| PBT 195 Pellets (wt %) | 100 | 99.9 | 99.85 | 99.8 | 99.75 |
| Butanediol (wt %) | — | 0.1 | 0.15 | 0.2 | 0.25 |

Properties

| | | | | | |
|---|---|---|---|---|---|
| Mw (g/mol) | 57,065 | 57,014 | 57,004 | 56,835 | 56,786 |
| Mn (g/mol) | 20,975 | 20,826 | 20,958 | 20,857 | 20,905 |
| Intrinsic viscosity (dl/g) | 0.686 | 0.690 | 0.689 | 0.691 | 0.687 |
| MVR, 6 min, 2.16 kg/250° C. (cc/10 min) | 57.1 | 71.3 | 76.2 | 80.4 | 81.3 |
| MVR, 18 min, 2.16 kg/250° C. (cc/10 min) | 61.3 | 74.5 | 81.7 | 86.9 | 83.3 |
| % change MVR from 6 to 18 min (%) | 7.4 | 4.5 | 7.2 | 8.1 | 2.5 |
| Tₘ₁ (° C.) | 224.2 | 113.8 | 222.9 | 224.0 | 223.4 |
| dHₘ₁ (J/g) | 49.8 | 50.2 | 55.3 | 51.5 | 52.4 |
| T_{c} (° C.) | 193.5 | 194.0 | 194.3 | 194.1 | 194.4 |
| dH_{c1} (J/g) | −53.0 | −53.2 | −56.0 | −54.6 | −56.4 |
| CEG (meq/kg) | 31.5 | 25.0 | 25.8 | 25.6 | 27.1 |
| MV Dwell 250° C. (Pa · s) | 124 | 98 | 99 | 80 | 90 |
| MV Dwell 30 minute (Pa · s) | 229 | 184 | 187 | 172 | 171 |
| % change in MV dwell (%) | | | | | |

The molecular weight data, comparing Example 9 to Examples 11-14, shows that the molecular weight did in fact decrease with addition of the butanediol. The CEG data shows that there is a slight drop in the CEG with addition of the butane diol.

The MVR values of the extruded PBT and are shown in FIG. 6. The high processing temperature of PBT (250° C.) and the low boiling point of the BDO (230° C.) suggests that the BDO would be escaping from the blend and reacting at the same time. FIG. 6 again surprisingly suggests that since the changes in Mw and viscosity were relatively well controlled, the BDO loss was minimal. The relatively small change between the 6 and 18 minute MVR dwell at 250° C., as shown in FIG. 3, further indicates that the reaction is largely complete in the extruder with the percentage of any further MVR change in most instances below 20%.

RHEOM01 dwell tests were performed on Examples 9-13 at a temperature of 240° C. and the results are shown in FIG. 7. In FIG. 7, the data shows that the examples that were mixed with the butane diol have good melt stability with less change in viscosity than that of Example 9. Without intending to be limited by theory, is believed that the high end group concentration may make these compositions more reactive than the compositions of Examples 4-8.

The CEG concentration can be determined in accordance with ASTM D7409-15. The CEG concentration can be determined by dissolution of poly(alkylene terephthalate) in a mixture of solvents at room temperature; suppressing ionic formation by adding a second substance for sharp equivalence point determination; and titrating the solution against potassium hydroxide using potentiometric or colorimetric method after addition of bromophenol blue indicator. The concentration of hydroxyl end groups can be determined in accordance with ASTM D4274-21.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

As used herein, “a,” “an,” “the,” and “at least one” do not denote a limitation of quantity, and are intended to cover both the singular and plural, unless the context clearly indicates otherwise. For example, “an element” has the same meaning as “at least one element,” unless the context clearly indicates otherwise. The term “combination” is inclusive of blends, mixtures, alloys, reaction products, and the like. Also, “at least one of” means that the list is inclusive of each element individually, as well as combinations of two or more elements of the list, and combinations of at least one element of the list with like elements not named.

The term “or” means “and/or” unless clearly indicated otherwise by context. Reference throughout the specification to “an aspect”, “another aspect”, “some aspects”, and so forth, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” e.g. 10 to 23 wt %, etc.

Unless defined otherwise, technical and scientific terms used herein have the same meaning as is commonly understood by one of skill in the art to which this disclosure belongs.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method for reducing the molecular weight of a polyester, comprising:
extruding a composition comprising a chain scission agent and a polyester in a molten state to form a modified polyester;
wherein the extruding occurs at a temperature of 230 to 330° C. in an extruder comprising at least one screw rotating at a speed of 50 to 500 revolutions per minute;
wherein the chain scission agent is present in an amount of 0.1 to 5 weight percent based on the total weight of the composition; wherein the chain scission agent comprises a C₂₋₁₂ alkane diol;
wherein the polyester comprises a C₂₋₁₂ alkyl phthalate polyester having a weight average molecular weight, Mwᵢ, of 15,000 to 100,000 g/mol determined using gel permeation chromatography based on polystyrene standards; and
wherein the modified polyester has a weight average molecular weight, Mw_{f}, of at least 5% less than the weight average molecular weight of the polyester.

2. The method according to claim 1, wherein the extruding the chain scission agent comprises transferring the chain scission agent through a melt line to the extruder; and mixing the chain scission agent and the polyester in an in-line mixer.

3. The method according to claim 3, wherein a temperature of the melt line is 230 to 260° C.

4. A method for reducing the molecular weight of a polyester comprising:
adding a chain scission agent to a polyester in a molten state in an in-line mixer to form a polyester composition; wherein the polyester comprises a C₂₋₁₂ alkyl phthalate polyester having a weight average molecular weight, Mwᵢ, of 15,000 to 100,000 g/mol determined using gel permeation chromatography based on polystyrene standards;
wherein the adding occurs at a temperature of 230 to 330° C.; wherein the in-line mixer is at least one static mixer having a length of at least 50 cm;
wherein the chain scission agent is present in an amount of 0.1 to 5 weight percent based on the total weight of the composition; wherein the chain scission agent comprises a C₂₋₁₂ alkane diol; and
wherein the modified polyester has a weight average molecular weight, Mw_{f}, of at least 5% less than the weight average molecular weight of the polyester.

5. The method according to claim 1, further comprising reacting an alkane diol and terephthalic acid in a continuous polymerization reaction to form the polyester; and
extruding the composition during the continuous polymerization reaction, but after a final polymerization.

6. The method according to claim 5, pelletizing the modified polyester after extruding to form pellets; and wherein the pellets comprise cylinders with an average length of 2.0 to 6.0 mm, an average diameter of 0.5 to 4.0 mm, and wherein the pellets have at least one angular face and wherein the surfaces defining the angular face meet at an angle of 60 to 120 degrees.

7. The method according to claim 1; wherein at least one of
an amount of the hydroxyl end groups of the modified polyester is 50 to 250 meq/kg as determined in accordance with ASTM D4274-21;
a carboxylic acid end group concentration of the modified polyester is 20 to 100 meq/kg as determined in accordance with ASTM D7409-15; or
a ratio of the hydroxyl end groups to the carboxylic end groups of the modified polyester is 1.2 to 2.5.

8. The method according to claim 1, further comprising melting a plurality of polyester pellets to form the polyester in the molten state and then extruding the composition.

9. The method according to claim 1, wherein a weight ratio of the chain scission agent to the polyester is 0.01:1 to 0.5:1.

10. The method according to claim 1, wherein the chain scission agent comprises less than or equal to 1 weight percent of the combined weight of each of the following hydroxy butyraldehyde, succinic aldehyde, succinic semialdehyde, succinic acid, hydroxy butyrate, butene diol, butylene diol, tetrahydrofuran, ethylene glycol, and propylene glycol, based on the total weight of the chain scission agent.

11. The method according to claim 1, wherein the polyester comprises at least 50 ppm by weight of at least one of titanium, tin, antinomy, or a combination comprising at least two of the foregoing based on the total weight of the polyester.

12. The method according to claim 1, wherein the polyester comprises less than or equal to 1,000 ppm by weight of a phosphorous containing compound based on the total weight of the polyester based on the total weight of the polyester.

13. The method according to claim 1, wherein the polyester comprises less than or equal to 1 ppm by weight of lead, mercury, cadmium, thallium, chromium, arsenic, or a combination comprising at least two of the foregoing based on the total weight of the polyester.

14. The method according to claim 1, wherein the modified polyester has a carboxylic acid end group concentration of 20 to 80 meq/kg as determined in accordance with ASTM D7409-15.
